(19) United States
(12) Patent Application Publication
(10) Pub. No.: US 2015/0258496 A1
(43) Pub. Date: Sep. 17, 2015

(54) Hybrid PGM-ZPGM TWC Exhaust Treatment Systems

(71) Applicant: Clean Diesel Technologies, Inc., Oxnard, CA (US)

(72) Inventors: Randal L. Hatfield, Port Hueneme, CA (US); Stephen J. Golden, Santa Barbara, CA (US)

(21) Appl. No.: 14/723,688

(22) Filed: May 28, 2015

Related U.S. Application Data
(63) Continuation-in-part of application No. 14/090,821, filed on Nov. 26, 2013.

(51) Int. Cl. B01D 53/94; B01J 21/04; B01J 23/46; B01J 23/20; B01J 23/10; B01J 35/00; B01J 23/889

(52) U.S. Cl. CPC B01D 53/9477; B01J 35/0006; B01J 21/04; B01J 23/8892; B01J 23/20; B01J 23/10; B01J 23/464; B01D 53/945; B01D 2255/1023; B01D 2255/1025; B01D 2255/2066; B01D 2255/20715; B01D 2255/2073; B01D 2255/20761; B01D 2255/2092; B01D 2255/405; B01D 2255/9022

(57) ABSTRACT

Hybrid PGM-ZPGM three-way catalyst (TWC) exhaust treatment systems are disclosed. The hybrid PGM-ZPGM TWC systems include a PGM close-coupled catalytic converter followed by an underfloor catalytic converter. The underfloor catalytic converter includes a ZPGM-based catalyst. Additionally, the underfloor catalytic converter can also be a PGM/ZPGM zone coated catalytic converter. The disclosed hybrid TWC systems comprising PGM-based and ZPGM-based catalysts can replace pure PGM-based exhaust treatment systems.

### CROSS-REFERENCE TO RELATED APPLICATIONS

This application is a continuation-in-part of U.S. patent application Ser. No. 14/090,821, filed Nov. 26, 2013, entitled “ZPGM Underfloor Catalyst for Hybrid Exhaust Treatment Systems,” which is incorporated herein by reference as if set forth in its entirety.

### FIELD OF THE DISCLOSURE

The present disclosure relates generally to exhaust treatment systems, and more particularly, to hybrid PGM-ZPGM three-way catalyst (TWC) exhaust treatment systems.

### BACKGROUND INFORMATION

Catalysts within catalytic converters have been used to decrease the pollution associated with exhaust from various sources, such as, automobiles, motorcycles, boats, generators, and other engine-equipped machines. Significant pollutants contained within the exhaust gas of gasoline and natural gas engines include carbon monoxide (CO), unburned hydrocarbons (HC), and nitrogen oxides (NO_{X}), among others.

Conventional gasoline exhaust treatment systems employ three-way catalysts technology and are referred to as three-way catalyst (TWC) systems. TWC systems convert the CO, HC and NO_{X} into less harmful pollutants. Typically, TWC systems include a substrate structure upon which supporting and sometimes promoting oxides are deposited. Catalysts, based on platinum group metals (PGM), are then deposited upon the supporting oxides. Conventional PGM materials include Pt, Rh, Pd, Ir, or combinations thereof. Although PGM catalyst materials are effective for toxic emission control and have been commercialized by the emissions control industry, PGM materials are scarce and expensive. This high cost remains a critical factor for wide spread applications of these catalyst materials.

Therefore, there is a need to provide a lower cost TWC system exhibiting catalytic properties substantially similar to or better than the catalytic properties exhibited by TWC systems employing PGM catalyst materials.

### SUMMARY

The present disclosure describes hybrid PGM-ZPGM three-way catalyst (TWC) exhaust treatment systems that are capable to comply with emissions standards by employing ZPGM-based catalysts within catalytic converters. Further, the hybrid PGM-ZPGM TWC exhaust treatment systems include a close-coupled converter and an underfloor converter.

In some embodiments, the close-coupled converter includes PGM-based catalysts and is designed to be commonly exposed to high temperatures. In these embodiments, the PGM-based catalysts include platinum (Pt), palladium (Pd), rhodium (Rd), iridium (Ir), by either themselves, or combinations thereof of different loadings.

In some embodiments, the underfloor converter includes ZPGM-based catalysts and is exposed to lower temperatures compared to close-coupled converter. In other embodiments, the underfloor converter is zone coated and includes PGM-based catalysts and ZPGM-based catalysts. In these embodiments, the underfloor converter is coated with PGM-based catalysts on one side and ZPGM-based catalysts on the other side.

In some embodiments, the ZPGM-based catalysts within underfloor converter comprise a suitable substrate, a washcoat (WC) layer, and an overcoat (OC) layer. In these embodiments, the suitable substrate is a refractive material, ceramic substrate, honeycomb structure, metallic substrate, ceramic foam, metallic foam, reticulated foam, or suitable combinations thereof. Further to these embodiments, the WC layer is implemented as a carrier material oxide, such as, for example alumina, silica, titanium dioxide, lanthanides-doped zirconia, cerium-zirconium oxides, or admixture thereof.

In these embodiments, the OC layer includes ZPGM catalyst compositions supported on a suitable support oxide. Examples of suitable support oxides include MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂-10% ZrO₂, TiO₂-10% Nb₂O₅, SnO₂—TiO₂, ZrO₂—SnO₂—TiO₂, BaZrO₃, BaTiO₃, BaCeO₃, ZrO₂—P₆O₁₁, ZrO₂—Y₂O₃, ZrO₂—Nb₂O₅, Al—Zr—Nb, and Al—Zr—La, amongst others. Further to these embodiments, the ZPGM catalyst compositions include first row of transition metals, a spinel structure (e.g., binary and ternary spinels), a perovskite structure (e.g., Y—Mn perovskite), a fluorite structure, a brookite or pseudo-brookite structure (e.g., YMn₂O₅ pseudo-brookite), or the like.

The disclosed hybrid TWC exhaust treatment systems comprising PGM-based and ZPGM-based catalysts can replace pure PGM-based exhaust treatment systems.

Numerous other aspects, features, and benefits of the present disclosure may be made apparent from the following detailed description.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a graphical representation illustrating a hybrid PGM-ZPGM three-way catalyst (TWC) exhaust treatment system portion of an engine system that includes a close-coupled converter and an underfloor converter, according to an embodiment.

FIG. 2 is a graphical representation illustrating a comparison of NO_{X} conversion percentages for TWC converter systems 1, 2 and 3 at three (3) different temperatures, according to an embodiment.

FIG. 3 is a graphical representation illustrating a comparison of CO conversion percentages for TWC converter systems 1, 2 and 3 at three (3) different temperatures, according to an embodiment.

FIG. 4 is a graphical representation illustrating a comparison of THC conversion percentages for TWC converter systems 1, 2 and 3 at three (3) different temperatures, according to an embodiment.

FIG. 5 is a graphical representation illustrating a comparison of NO_{X} conversion percentages for TWC converter systems 4, 5 and 6 at three (3) different temperatures, according to an embodiment.

FIG. 6 is a graphical representation illustrating a comparison of CO conversion percentages for TWC converter systems 4, 5 and 6 at three (3) different temperatures, according to an embodiment.

FIG. 7 is a graphical representation illustrating a comparison of THC conversion percentages for TWC converter systems 4, 5 and 6 at three (3) different temperatures, according to an embodiment.

FIG. 8 is a graphical representation illustrating a comparison of NO_{X} conversion percentages for TWC converter systems 7, 8 and 9 at three (3) different temperatures, according to an embodiment.

FIG. 9 is a graphical representation illustrating a comparison of CO conversion percentages for TWC converter systems 7, 8 and 9 at three (3) different temperatures, according to an embodiment.

FIG. 10 is a graphical representation illustrating a comparison of THC conversion percentages for TWC converter systems 7, 8 and 9 at three (3) different temperatures, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms have the following definitions:

“Catalyst” refers to one or more materials that may be of use in the conversion of one or more other materials.

“Conversion” refers to the chemical alteration of at least one material into one or more other materials.

“Lean condition” refers to exhaust gas condition with an R-value less than 1, excess oxidants.

“Platinum Group Metal (PGM)” refers to platinum, palladium, ruthenium, iridium, osmium, and rhodium.

“R-value” refers to the value obtained by dividing the total reducing potential of the gas mixture (in moles of oxygen) by the total oxidizing potential of the gas mixture (in moles of oxygen).

“Rich condition” refers to exhaust gas condition with an R-value greater than 1, excess reductants.

Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“Zero-platinum group (ZPGM) catalyst” refers to a catalyst completely or substantially free of platinum group metals (PGM).

### Description of the Disclosure

The present disclosure describes hybrid PGM-ZPGM three-way catalyst (TWC) exhaust treatment systems that are capable to comply with emissions standards by employing ZPGM-based catalysts within catalytic converters. Further, the hybrid PGM-ZPGM TWC exhaust treatment systems include a PGM close-coupled converter and an underfloor converter.

### Configuration of a Hybrid PGM-ZPGM TWC Exhaust Treatment System

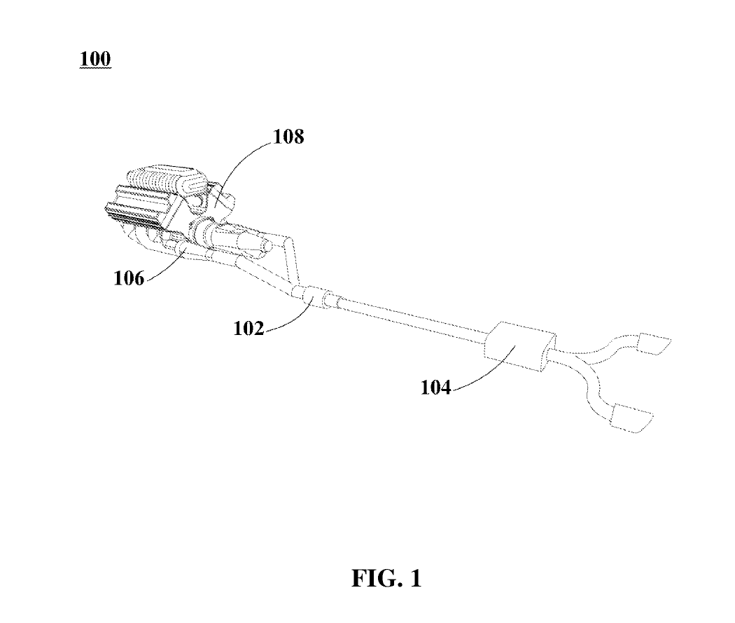

FIG. 1 is a graphical representation illustrating a hybrid PGM-ZPGM three-way catalyst (TWC) exhaust treatment system portion of an engine system that includes a close-coupled converter and an underfloor converter, according to an embodiment. In FIG. 1, engine system 100 includes close-coupled converter 102, underfloor converter 104, exhaust manifold 106, and engine 108. In FIG. 1, engine 108 is mechanically coupled to and in fluidic communication with exhaust manifold 106. Exhaust manifold 106 is mechanically coupled to and in fluidic communication with close-coupled converter 102. Further, close-coupled converter 102 is mechanically coupled to and in fluidic communication with underfloor converter 104. In some embodiments, the bed-volume of close-coupled converter 102 and underfloor converter 104 varies and is optimized according to each particular application. It should be understood that engine system 100 can include more components, less components, or different components depending on desired goals.

In some embodiments, close-coupled converter 102 includes PGM-based catalyst and is designed to be commonly exposed to high temperatures, for example, temperatures from about 800° C. to about 1000° C. In these embodiments, the PGM-based catalysts include platinum (Pt), palladium (Pd), rhodium (Rd), iridium (Ir), by either themselves, or combinations thereof of different loadings.

In some embodiments, underfloor converter 104 is generally positioned under the floor of the passenger compartment of the vehicle and is exposed to lower temperatures compared to close-coupled converter 102, for example, from about 200° C. to about 600° C. In these embodiments, underfloor converter 104 includes ZPGM-based catalyst. In other embodiments, underfloor converter 104 is zone coated and includes PGM-based catalyst(s) and ZPGM-based catalyst(s) compositions. In these embodiments, underfloor converter 104 is coated with a PGM-based catalyst(s) on one side and a ZPGM-based catalyst(s) on the other side.

In some embodiments, the ZPGM-based catalyst within underfloor converter 104 comprises a suitable substrate, a washcoat (WC) layer, and an overcoat (OC) layer. In these embodiments, the suitable substrate is a refractive material, ceramic substrate, honeycomb structure, metallic substrate, ceramic foam, metallic foam, reticulated foam, or suitable combinations thereof. Further to these embodiments, the WC layer is implemented as a carrier material oxide, such as, for example alumina, silica, titanium dioxide, lanthanides-doped zirconia, cerium-zirconium oxides, or admixture thereof.

In these embodiments, the OC layer includes ZPGM catalyst compositions supported on a suitable support oxide. Examples of suitable support oxides include MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂-10% ZrO₂, TiO₂-10% Nb₂O₅, SnO₂—TiO₂, ZrO₂—SnO₂—TiO₂, BaZrO₃, BaTiO₃, BaCeO₃, ZrO₂—P₆O₁₁, ZrO₂—Y₂O₃, ZrO₂—Nb₂O₅, Al—Zr—Nb, and Al—Zr—La, amongst others. Further to these embodiments, the ZPGM catalyst compositions include first row of transition metals, a spinel structure (e.g., binary and ternary spinels), a perovskite structure (e.g., Y—Mn perovskite), a fluorite structure, a brookite or pseudo-brookite structure (e.g., YMn₂O₅ pseudo-brookite), or the like. In other embodiments, underfloor converter 104 can include additional, fewer, or differently arranged components and layers than those previously described above.

### Material Composition and Preparation of Samples for Variations of the TWC Converter Configuration

In a first exemplary embodiment, TWC converter system 1 includes PGM close-coupled converter 1 and underfloor converter 1. In this embodiment, PGM close-coupled converter 1 includes a 0/12/6 (Platinum/Palladium/Rhodium) commercial PGM material. Further to this embodiment, PGM close-coupled converter 1 is manufactured having a substantially cylindrical shape with diameter of about 4.16″ and volume of about 1 L. Still further to this embodiment, close-coupled core sample 1 having about 1″ of diameter and about 1.181″ of length is taken from PGM close-coupled converter 1 (e.g., by using a diamond core drill). In this embodiment, close-coupled core sample 1 is then aged within a laboratory bench simulation at approximately 1000° C. for about 20 hours, with cycles of about 55 seconds in stoichiometric conditions and about 5 seconds in lean conditions, employing about 5% oxygen by volume. Further to this embodiment, underfloor converter 1 includes a cordierite substrate. Still further to this embodiment, underfloor converter 1 is manufactured having a substantially cylindrical shape with diameter of about 4.16″ and volume of about 1 L. In this embodiment, underfloor core sample 1 having about 1″ of diameter and about 1.181″ of length is taken from underfloor converter 1.

In a second exemplary embodiment, TWC converter system 2 includes aforementioned PGM close-coupled converter 1 and underfloor converter 2. In this embodiment, ZPGM underfloor converter 2 includes a ZPGM-based catalyst comprising a suitable substrate, a buffer layer of about 125 g/L of alumina as WC layer, and an OC layer of Cu—Mn spinel supported on a Nb-doped zirconia (ZrO₂-25% Nb₂O₅) support oxide having a coating concentration of about 100 g/L. Further to this embodiment, underfloor converter 2 is manufactured having a substantially cylindrical shape with diameter of about 4.16″ and volume of about 1 L. Still further to this embodiment, underfloor core sample 2 having about 1″ of diameter and about 1.181″ of length is taken from underfloor converter 2. In this embodiment, underfloor core sample 2 is then aged within a laboratory bench simulation at approximately 800° C. for about 20 hours, with cycles of about 55 seconds in stoichiometric conditions and about 5 seconds in lean conditions, employing about 5% oxygen by volume.

In a third exemplary embodiment, TWC converter system 3 includes aforementioned PGM close-coupled converter 1 and underfloor converter 3. In this embodiment, underfloor converter 3 includes a ZPGM-based catalyst comprising a suitable substrate, a buffer layer of about 125 g/L of alumina as WC layer, and an OC layer of Cu—Mn spinel supported on a Pr-doped zirconia support oxide having a coating concentration of about 100 g/L. Further to this embodiment, underfloor converter 3 is manufactured having a substantially cylindrical shape with diameter of about 4.16″ and volume of about 1 L. Still further to this embodiment, underfloor core sample 3 having about 1″ of diameter and about 1.181″ of length is taken from underfloor converter 3. In this embodiment, underfloor core sample 3 is then aged within a laboratory bench simulation at approximately 800° C. for about 20 hours, with cycles of about 55 seconds in stoichiometric conditions and about 5 seconds in lean conditions, employing about 5% oxygen by volume.

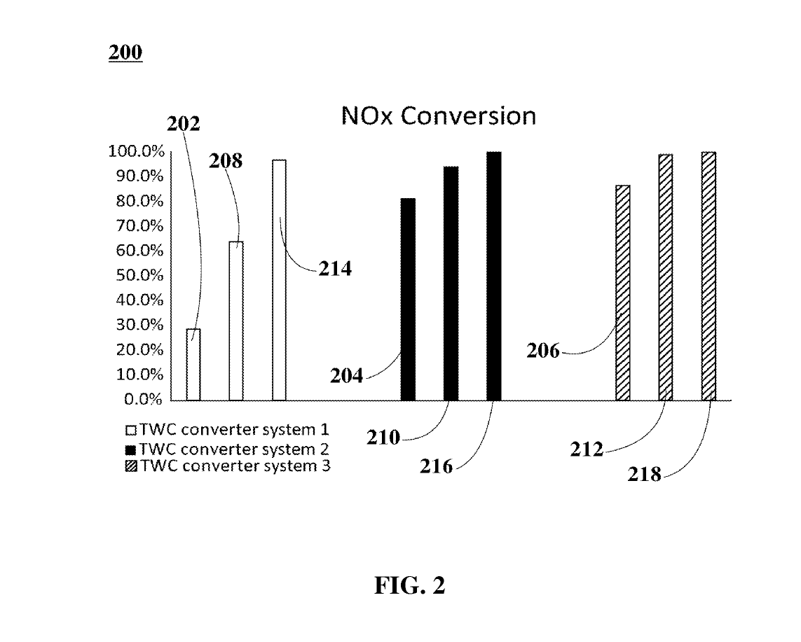

In some embodiments, a first set of standard tests within a bench reactor were performed at three (3) different temperatures to determine the TWC catalytic performance of TWC converter systems 1, 2, and 3, at an average R-value of about 1.2. These test results are illustrated in FIGS. 2-4, below.

FIG. 2 is a graphical representation illustrating a comparison of NO_{X} conversion percentages for TWC converter systems 1, 2 and 3 at three (3) different temperatures, according to an embodiment. In FIG. 2, NOx conversion results 200 include bar 202, bar 204, bar 206, bar 208, bar 210, bar 212, bar 214, bar 216, and bar 218.

In some embodiments, bar 202 illustrates the NO_{X} conversion percentage associated with TWC converter system 1 at about 350° C. In these embodiments, bar 204 illustrates the NO_{X} conversion percentage associated with TWC converter system 2 at about 350° C. Further to these embodiments, bar 206 illustrates the NO_{X} conversion percentage associated with TWC converter system 3 at about 350° C. Still further to these embodiments, TWC converter systems 1, 2, and 3 operating at about 350° C. exhibit NO_{X} conversion percentages of about 28.6%, 81.2%, and 86.5%, respectively. In these embodiments, TWC converter systems 2 and 3 each exhibit a significantly higher improvement in NO_{X} conversion percentage as compared to TWC converter system 1.

In other embodiments, bar 208 illustrates the NO_{X} conversion percentage associated with TWC converter system 1 at about 400° C. In these embodiments, bar 210 illustrates the NO_{X} conversion percentage associated with TWC converter system 2 at about 400° C. Further to these embodiments, bar 212 illustrates the NO_{X} conversion percentage associated with TWC converter system 3 at about 400° C. Still further to these embodiments, TWC converter systems 1, 2, and 3 exhibit NO_{X} conversion percentages of about 63.9%, 94.0%, and 99.0%, respectively. In these embodiments, TWC converter systems 2 and 3 each exhibit a significant improvement in NO_{X} conversion percentage as compared to TWC converter system 1.

In further embodiments, bar 214 illustrates the NO_{X} conversion percentage associated with TWC converter system 1 at about 500° C. In these embodiments, bar 216 illustrates the NO_{X} conversion percentage associated with TWC converter system 2 at about 500° C. Further to these embodiments, bar 218 illustrates the NO_{X} conversion percentage associated with TWC converter system 3 at about 500° C. Still further to these embodiments, TWC converter systems 1, 2, and 3 exhibit NO_{X} conversion percentages of about 96.8%, 100%, and 100%, respectively. In these embodiments, TWC converter systems 2 and 3 each exhibit a slight improvement in NO_{X} conversion percentage as compared to TWC converter system 1.

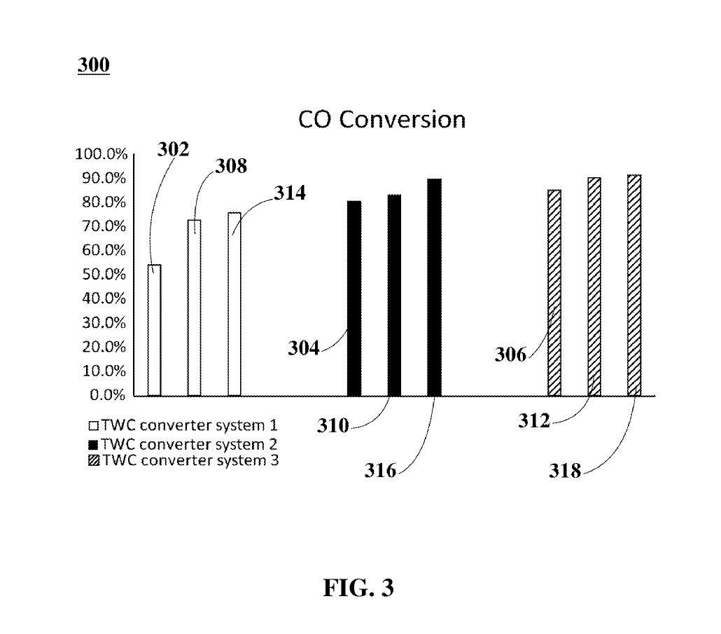

FIG. 3 is a graphical representation illustrating a comparison of CO conversion percentages for TWC converter systems 1, 2 and 3 at three (3) different temperatures, according to an embodiment. In FIG. 3, CO conversion results 300 include bar 302, bar 304, bar 306, bar 308, bar 310, bar 312, bar 314, bar 316, and bar 318.

In some embodiments, bar 302 illustrates the CO conversion percentage associated with TWC converter system 1 at about 350° C. In these embodiments, bar 304 illustrates the CO conversion percentage associated with TWC converter system 2 at about 350° C. Further to these embodiments, bar 306 illustrates the CO conversion percentage associated with TWC converter system 3 at about 350° C. Still further to these embodiments, TWC converter systems 1, 2, and 3 exhibit CO conversion percentages of about 54.2%, 80.5%, and 85.1%, respectively. In these embodiments, TWC converter systems 2 and 3 each exhibit a significant improvement in CO conversion percentage as compared to TWC converter system 1.

In other embodiments, bar 308 illustrates the CO conversion percentage associated with TWC converter system 1 at about 400° C. In these embodiments, bar 310 illustrates the CO conversion percentage associated with TWC converter system 2 at about 400° C. Further to these embodiments, bar 312 illustrates the CO conversion percentage associated with TWC converter system 3 at about 400° C. Still further to these embodiments, TWC converter systems 1, 2, and 3 exhibit CO conversion percentages of about 72.8%, 83.1%, and 90.5%, respectively. In these embodiments, TWC converter systems 2 and 3 each exhibit a significant improvement in CO conversion percentage as compared to TWC converter system 1.

In further embodiments, bar 314 illustrates the CO conversion percentage associated with TWC converter system 1 at about 500° C. In these embodiments, bar 316 illustrates the CO conversion percentage associated with TWC converter system 2 at about 500° C. Further to these embodiments, bar 318 illustrates the CO conversion percentage associated with TWC converter system 3 at about 500° C. Still further to these embodiments, TWC converter systems 1, 2, and 3 exhibit CO conversion percentages of about 75.9%, 89.6%, and 91.4%, respectively. In these embodiments, TWC converter systems 2 and 3 each exhibit a significant improvement in CO conversion percentage as compared to TWC converter system 1.

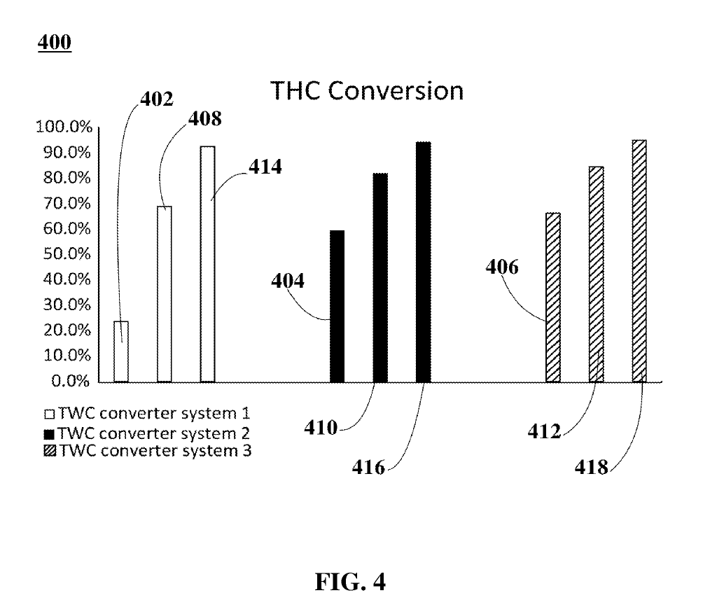

FIG. 4 is a graphical representation illustrating a comparison of THC conversion percentages for TWC converter systems 1, 2 and 3 at three (3) different temperatures, according to an embodiment. In FIG. 4, THC conversion results 400 include bar 402, bar 404, bar 406, bar 408, bar 410, bar 412, bar 414, bar 416, and bar 418.

In some embodiments, bar 402 illustrates the THC conversion percentage associated with TWC converter system 1 at about 350° C. In these embodiments, bar 404 illustrates the THC conversion percentage associated with TWC converter system 2 at about 350° C. Further to these embodiments, bar 406 illustrates the THC conversion percentage associated with TWC converter system 3 at about 350° C. Still further to these embodiments, TWC converter systems 1, 2, and 3 exhibit THC conversion percentages of about 23.6%, 59.3%, and 66.3%, respectively. In these embodiments, TWC converter systems 2 and 3 each exhibit a significantly higher improvement in THC conversion percentage as compared to TWC converter system 1.

In other embodiments, bar 408 illustrates the THC conversion percentage associated with TWC converter system 1 at about 400° C. In these embodiments, bar 410 illustrates the THC conversion percentage associated with TWC converter system 2 at about 400° C. Further to these embodiments, bar 412 illustrates the THC conversion percentage associated with TWC converter system 3 at about 400° C. Still further to these embodiments, TWC converter systems 1, 2, and 3 exhibit THC conversion percentages of about 69.0%, 81.8%, and 84.7%, respectively. In these embodiments, TWC converter systems 2 and 3 each exhibit a significant improvement in THC conversion percentage as compared to TWC converter system 1.

In further embodiments, bar 414 illustrates the THC conversion percentage associated with TWC converter system 1 at about 500° C. In these embodiments, bar 416 illustrates the THC conversion percentage associated with TWC converter system 2 at about 500° C. Further to these embodiments, bar 418 illustrates the THC conversion percentage associated with TWC converter system 3 at about 500° C. Still further to these embodiments, TWC converter systems 1, 2, and 3 exhibit THC conversion percentages of about 92.6%, 94.2%, and 95.0%, respectively. In these embodiments, TWC converter systems 2 and 3 each exhibit a slight improvement in THC conversion percentage as compared to TWC converter system 1.

In a fourth exemplary embodiment, TWC converter system 4 includes PGM close-coupled converter 2 and aforementioned underfloor converter 1. In this embodiment, PGM close-coupled converter 2 includes a 0/6/6 (Platinum/Palladium/Rhodium) PGM material. Further to this embodiment, PGM close-coupled converter 2 is manufactured having a substantially cylindrical shape with diameter of about 4.16″ and volume of about 1 L. Still further to this embodiment, close-coupled core sample 2 having about 1″ of diameter and about 1.181″ of length is taken from PGM close-coupled converter 2 (e.g., by using a diamond core drill). In this embodiment, close-coupled core sample 2 is then aged within a laboratory bench simulation at approximately 1000° C. for about 20 hours, with cycles of about 55 seconds in stoichiometric conditions and about 5 seconds in lean conditions, employing about 5% oxygen by volume.

In a fifth exemplary embodiment, TWC converter system 5 includes aforementioned PGM close-coupled converter 2 and aforementioned underfloor converter 2. In these embodiments, aforementioned close-coupled core sample 2 and aforementioned underfloor core sample 2 are then aged within a laboratory bench simulation at approximately 800° C. for about 20 hours, with cycles of about 55 seconds in stoichiometric conditions and about 5 seconds in lean conditions, employing about 5% oxygen by volume.

In a sixth exemplary embodiment, TWC converter system 6 includes aforementioned PGM close-coupled converter 2 and aforementioned underfloor converter 3. In these embodiments, aforementioned close-coupled core sample 2 and aforementioned underfloor core sample 3 are then aged within a laboratory bench simulation at approximately 800° C. for about 20 hours, with cycles of about 55 seconds in stoichiometric conditions and about 5 seconds in lean conditions, employing about 5% oxygen by volume.

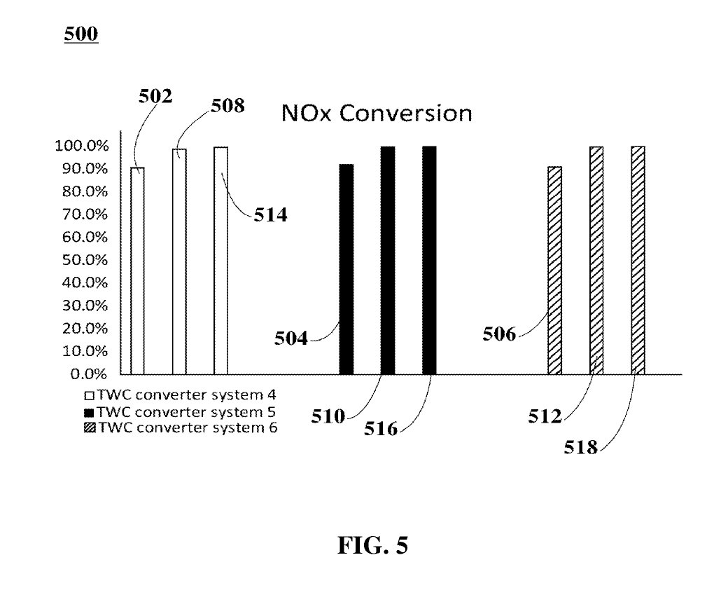

In some embodiments, a second set of standard tests within a bench reactor were performed at three (3) different temperatures to determine the TWC catalytic performance of TWC converter systems 4, 5, and 6 at an average R-value of about 1.2. These test results are illustrated in FIGS. 5-7, below.

FIG. 5 is a graphical representation illustrating a comparison of NO_{X} conversion percentages for TWC converter systems 4, 5 and 6 at three (3) different temperatures, according to an embodiment. In FIG. 5, NOx conversion results 500 include bar 502, bar 504, bar 506, bar 508, bar 510, bar 512, bar 514, bar 516, and bar 518.

In some embodiments, bar 502 illustrates the NO_{X} conversion percentage associated with TWC converter system 4 at about 350° C. In these embodiments, bar 504 illustrates the NO_{X} conversion percentage associated with TWC converter system 5 at about 350° C. Further to these embodiments, bar 506 illustrates the NO_{X} conversion percentage associated with TWC converter system 6 at about 350° C. Still further to these embodiments, TWC converter systems 4, 5, and 6 exhibit NO_{X} conversion percentages of about 90.7%, 92.1%, and 91.1%, respectively. In these embodiments, TWC converter systems 5 and 6 each exhibit a slight improvement in NO_{X} conversion percentage as compared to TWC converter system 4.

In other embodiments, bar 508 illustrates the NO_{X} conversion percentage associated with TWC converter system 4 at about 400° C. In these embodiments, bar 510 illustrates the NO_{X} conversion percentage associated with TWC converter system 5 at about 400° C. Further to these embodiments, bar 512 illustrates the NO_{X} conversion percentage associated with TWC converter system 6 at about 400° C. Still further to these embodiments, TWC converter systems 4, 5, and 6 exhibit NO_{X} conversion percentages of about 98.8%, 99.8%, and 99.8%%, respectively. In these embodiments, TWC converter systems 5 and 6 each exhibit a slight improvement in NO_{X} conversion percentage as compared to TWC converter system 4.

In further embodiments, bar 514 illustrates the NO_{X} conversion percentage associated with TWC converter system 4 at about 500° C. In these embodiments, bar 516 illustrates the NO_{X} conversion percentage associated with TWC converter system 5 at about 500° C. Further to these embodiments, bar 518 illustrates the NO_{X} conversion percentage associated with TWC converter system 6 at about 500° C. Still further to these embodiments, TWC converter systems 4, 5, and 6 exhibit NO_{X} conversion percentages of about 99.7%, 100%, and 100%, respectively. In these embodiments, TWC converter systems 4, 5, and 6 exhibit a substantially similar NO_{X} conversion percentage.

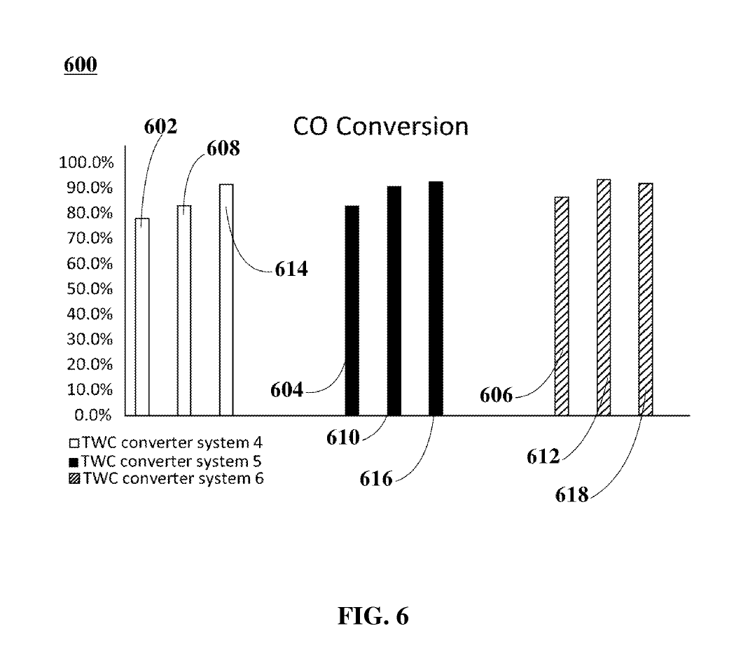

FIG. 6 is a graphical representation illustrating a comparison of CO conversion percentages for TWC converter systems 4, 5 and 6 at three (3) different temperatures, according to an embodiment. In FIG. 6, CO conversion results 600 include bar 602, bar 604, bar 606, bar 608, bar 610, bar 612, bar 614, bar 616, and bar 618.

In some embodiments, bar 602 illustrates the CO conversion percentage associated with TWC converter system 4 at about 350° C. In these embodiments, bar 604 illustrates the CO conversion percentage associated with TWC converter system 5 at about 350° C. Further to these embodiments, bar 606 illustrates the CO conversion percentage associated with TWC converter system 6 at about 350° C. Still further to these embodiments, TWC converter systems 4, 5, and 6 exhibit CO conversion percentages of about 78.2%, 83.0%, and 86.6%, respectively. In these embodiments, TWC converter systems 5 and 6 each exhibit an improvement in CO conversion percentage as compared to TWC converter system 4.

In other embodiments, bar 608 illustrates the CO conversion percentage associated with TWC converter system 4 at about 400° C. In these embodiments, bar 610 illustrates the CO conversion percentage associated with TWC converter system 5 at about 400° C. Further to these embodiments, bar 612 illustrates the CO conversion percentage associated with TWC converter system 6 at about 400° C. Still further to these embodiments, TWC converter systems 4, 5, and 6 exhibit CO conversion percentage of about 83.1%, 90.7%, and 93.4%, respectively. In these embodiments, TWC converter systems 5 and 6 each exhibit an improvement in CO conversion percentage as compared to TWC converter system 4.

In further embodiments, bar 614 illustrates the CO conversion percentage associated with TWC converter system 4 at about 500° C. In these embodiments, bar 616 illustrates the CO conversion percentage associated with TWC converter system 5 at about 500° C. Further to these embodiments, bar 618 illustrates the CO conversion percentage associated with TWC converter system 6 at about 500° C. Still further to these embodiments, TWC converter systems 4, 5, and 6 exhibit CO conversion percentages of about 91.7%, 92.6%, and 92.0%, respectively. In these embodiments, TWC converter systems 4, 5 and 6 exhibit a substantially similar CO conversion percentage.

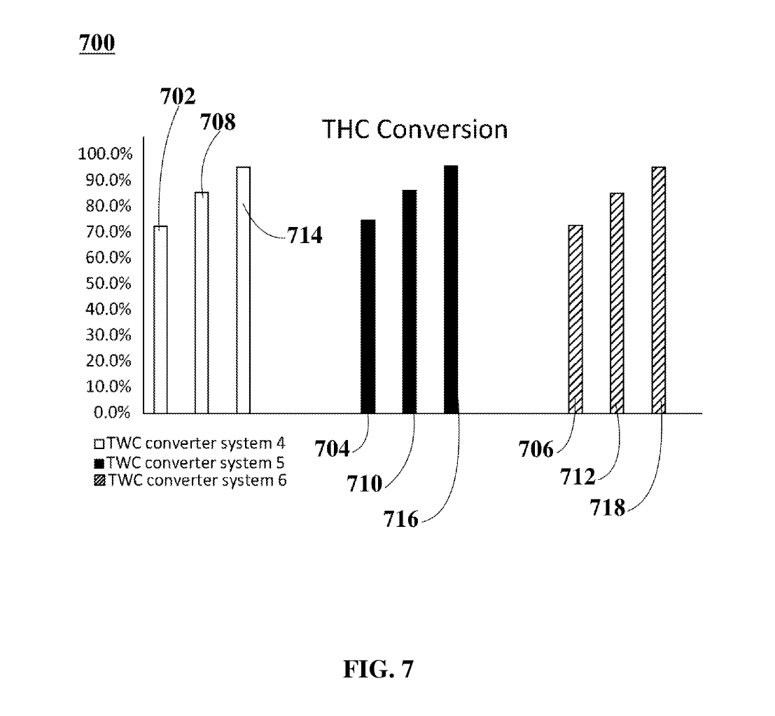

FIG. 7 is a graphical representation illustrating a comparison of THC conversion percentages for TWC converter systems 4, 5 and 6 at three (3) different temperatures, according to an embodiment. In FIG. 7, THC conversion results 700 include bar 702, bar 704, bar 706, bar 708, bar 710, bar 712, bar 714, bar 716, and bar 718.

In some embodiments, bar 702 illustrates the THC conversion percentage associated with TWC converter system 4 at about 350° C. In these embodiments, bar 704 illustrates the THC conversion percentage associated with TWC converter system 5 at about 350° C. Further to these embodiments, bar 706 illustrates the THC conversion percentage associated with TWC converter system 6 at about 350° C. Still further to these embodiments, TWC converter systems 4, 5, and 6 exhibit THC conversion percentages of about 72.4%, 74.8%, and 72.8%, respectively. In these embodiments, TWC converter systems 5 and 6 each exhibit a slight improvement in THC conversion percentage as compared to TWC converter system 4.

In other embodiments, bar 708 illustrates the THC conversion percentage associated with TWC converter system 4 at about 400° C. In these embodiments, bar 710 illustrates the THC conversion percentage associated with TWC converter system 5 at about 400° C. Further to these embodiments, bar 712 illustrates the THC conversion percentage associated with TWC converter system 6 at about 400° C. Still further to these embodiments, TWC converter systems 4, 5, and 6 exhibit THC conversion percentages of about 85.5%, 86.1%, and 85.1%, respectively. In these embodiments, TWC converter systems 4, 5, and 6 exhibit a substantially similar THC conversion percentage.

In further embodiments, bar 714 illustrates the THC conversion percentage associated with TWC converter system 4 at about 500° C. In these embodiments, bar 716 illustrates the THC conversion percentage associated with TWC converter system 5 at about 500° C. Further to these embodiments, bar 718 illustrates the THC conversion percentage associated with TWC converter system 6 at about 500° C. Still further to these embodiments, TWC converter systems 4, 5, and 6 exhibit THC conversion percentages of about 95.3%, 95.5%, and 95.3%, respectively. In these embodiments, TWC converter systems 4, 5, and 6 exhibit a substantially similar THC conversion percentage.

In a seventh exemplary embodiment, TWC converter system 7 includes PGM close-coupled converter 3 and aforementioned underfloor converter 1. In this embodiments, PGM close-coupled converter 3 includes a 0/20/0 (Palladium only) PGM material. Further to this embodiment, PGM close-coupled converter 3 is manufactured having a substantially cylindrical shape with diameter of about 4.16″ and volume of about 1 L. Still further to this embodiment, close-coupled core sample 3 having about 1″ of diameter and about 1.181″ of length is taken from PGM close-coupled converter 3 (e.g., by using a diamond core drill). In this embodiment, close-coupled core sample 3 is then aged within a laboratory bench simulation at approximately 1000° C. for about 20 hours, with cycles of about 55 seconds in stoichiometric conditions and about 5 seconds in lean conditions, employing about 5% oxygen by volume.

In an eight exemplary embodiment, TWC converter system 8 includes aforementioned PGM close-coupled converter 3 and aforementioned underfloor converter 2. In these embodiments, aforementioned close-coupled core sample 3 and aforementioned underfloor core sample 2 are then aged within a laboratory bench simulation at approximately 800° C. for about 20 hours, with cycles of about 55 seconds in stoichiometric conditions and about 5 seconds in lean conditions, employing about 5% oxygen by volume.

In a ninth exemplary embodiment, TWC converter system 9 includes aforementioned PGM close-coupled converter 3 and aforementioned underfloor converter 3. In these embodiments, aforementioned close-coupled core sample 3 and aforementioned underfloor core sample 3 are then aged within a laboratory bench simulation at approximately 800° C. for about 20 hours, with cycles of about 55 seconds in stoichiometric conditions and about 5 seconds in lean conditions, employing about 5% oxygen by volume.

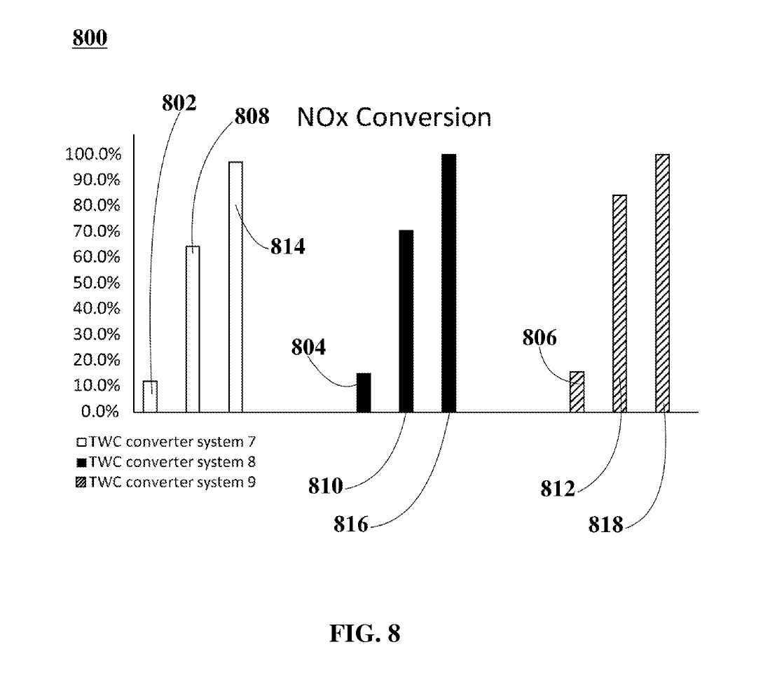

In some embodiments, a third set of standard tests within a bench reactor were performed at three (3) different temperatures to determine the TWC catalytic performance of TWC converter systems 7, 8, and 9 at an average R-value of about 1.2. These test results are illustrated in FIGS. 8-10, below.

FIG. 8 is a graphical representation illustrating a comparison of NO_{X} conversion percentages for TWC converter systems 7, 8 and 9 at three (3) different temperatures, according to an embodiment. In FIG. 8, NOx conversion results 800 include bar 802, bar 804, bar 806, bar 808, bar 810, bar 812, bar 814, bar 816, and bar 818.

In some embodiments, bar 802 illustrates the NO_{X} conversion percentage associated with TWC converter system 7 at about 350° C. In these embodiments, bar 804 illustrates the NO_{X} conversion percentage associated with TWC converter system 8 at about 350° C. Further to these embodiments, bar 806 illustrates the NO_{X} conversion percentage associated with TWC converter system 9 at about 350° C. Still further to these embodiments, TWC converter systems 7, 8, and 9 exhibit NO_{X} conversion percentages of about 11.9%, 15.0%, and 15.7%, respectively. In these embodiments, TWC converter systems 8 and 9 each exhibit a slight improvement in NO_{X} conversion percentage as compared to TWC converter system 7.

In other embodiments, bar 808 illustrates the NO_{X} conversion percentage associated with TWC converter system 7 at about 400° C. In these embodiments, bar 810 illustrates the NO_{X} conversion percentage associated with TWC converter system 8 at about 400° C. Further to these embodiments, bar 812 illustrates the NO_{X} conversion percentage associated with TWC converter system 9 at about 400° C. Still further to these embodiments, TWC converter systems 7, 8, and 9 exhibit NO_{X} conversion percentages of about 64.4%, 70.4%, and 84.2%, respectively. In these embodiments, TWC converter systems 8 and 9 each exhibit a significant improvement in NO_{X} conversion percentage as compared to TWC converter system 7.

In further embodiments, bar 814 illustrates the NO_{X} conversion percentage associated with TWC converter system 7 at about 500° C. In these embodiments, bar 816 illustrates the NO_{X} conversion percentage associated with TWC converter system 8 at about 500° C. Further to these embodiments, bar 818 illustrates the NO_{X} conversion percentage associated with TWC converter system 9 at about 500° C. Still further to these embodiments, TWC converter systems 7, 8, and 9 exhibit NO_{X} conversion percentages of about 97.2%, 100%, and 100%, respectively. In these embodiments, TWC converter systems 8 and 9 each exhibit an improvement in NO_{X} conversion percentage as compared to TWC converter system 7.

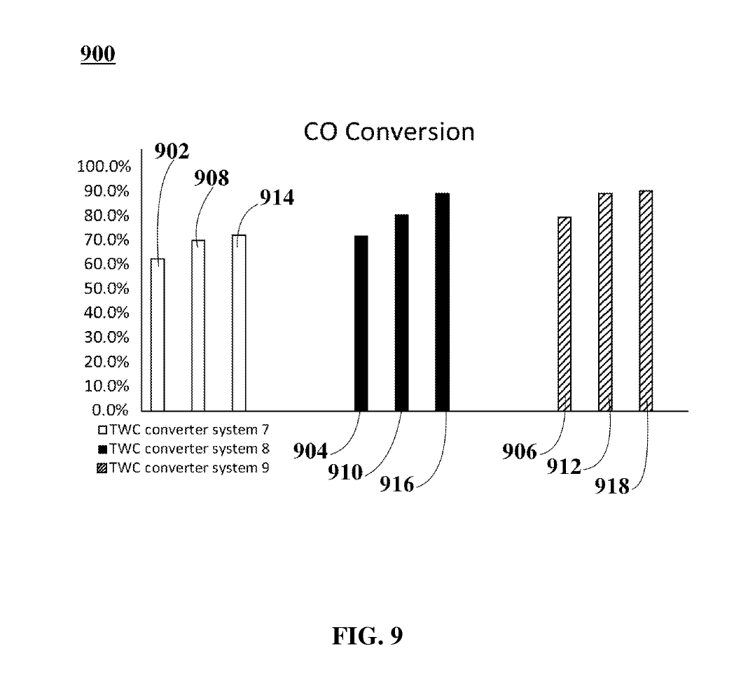

FIG. 9 is a graphical representation illustrating a comparison of CO conversion percentages for TWC converter systems 7, 8 and 9 at three (3) different temperatures, according to an embodiment. In FIG. 9, CO conversion results 900 include bar 902, bar 904, bar 906, bar 908, bar 910, bar 912, bar 914, bar 916, and bar 918.

In some embodiments, bar 902 illustrates the CO conversion percentage associated with TWC converter system 7 at about 350° C. In these embodiments, bar 904 illustrates the CO conversion percentage associated with TWC converter system 8 at about 350° C. Further to these embodiments, bar 906 illustrates the CO conversion percentage associated with TWC converter system 9 at about 350° C. Still further to these embodiments, TWC converter systems 7, 8, and 9 exhibit CO conversion percentages of about 62.4%, 71.8%, and 79.6%, respectively. In these embodiments, TWC converter systems 8 and 9 each exhibit a significant improvement in CO conversion percentage as compared to TWC converter system 7.

In other embodiments, bar 908 illustrates the CO conversion percentage associated with TWC converter system 7 at about 400° C. In these embodiments, bar 910 illustrates the CO conversion percentage associated with TWC converter system 8 at about 400° C. Further to these embodiments, bar 912 illustrates the CO conversion percentage associated with TWC converter system 9 at about 400° C. Still further to these embodiments, TWC converter systems 7, 8, and 9 exhibit CO conversion percentages of about 70.1%, 80.5%, and 89.2%, respectively. In these embodiments, TWC converter systems 8 and 9 each exhibit a significant improvement in CO conversion percentage as compared to TWC converter system 7.

In further embodiments, bar 914 illustrates the CO conversion percentage associated with TWC converter system 7 at about 500° C. In these embodiments, bar 916 illustrates the CO conversion percentage associated with TWC converter system 8 at about 500° C. Further to these embodiments, bar 918 illustrates the CO conversion percentage associated with TWC converter system 9 at about 500° C. Still further to these embodiments, TWC converter systems 7, 8, and 9 exhibit CO conversion percentages of about 72.2%, 89.2%, and 90.5%, respectively. In these embodiments, TWC converter systems 8 and 9 each exhibit a significant improvement in CO conversion percentage as compared to TWC converter system 7.

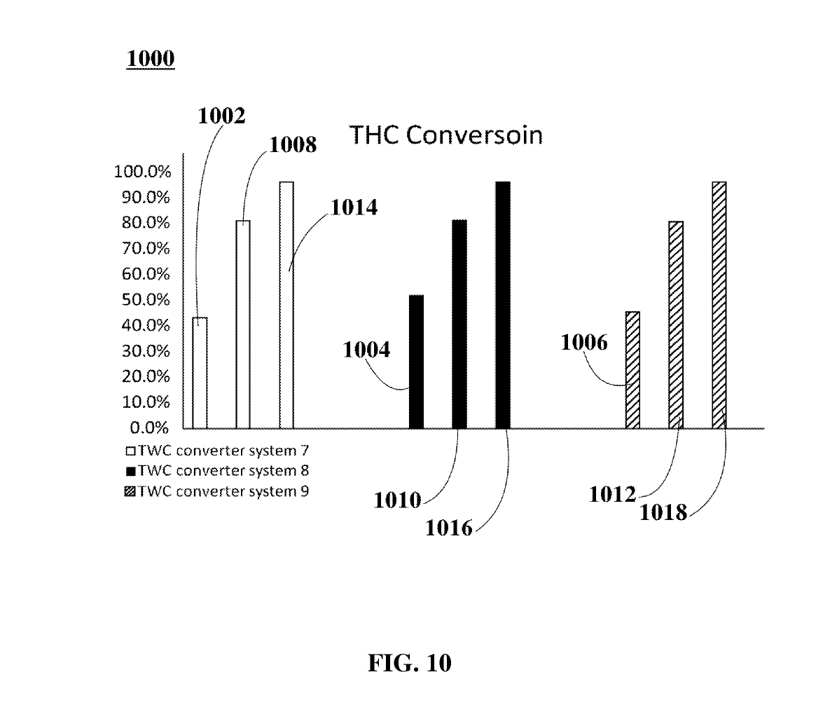

FIG. 10 is a graphical representation illustrating a comparison of THC conversion percentages for TWC converter systems 7, 8 and 9 at three (3) different temperatures, according to an embodiment. In FIG. 10, THC conversion results 1000 include bar 1002, bar 1004, bar 1006, bar 1008, bar 1010, bar 1012, bar 1014, bar 1016, and bar 1018.

In some embodiments, bar 1002 illustrates the THC conversion percentage associated with TWC converter system 7 at about 350° C. In these embodiments, bar 1004 illustrates the THC conversion percentage associated with TWC converter system 8 at about 350° C. Further to these embodiments, bar 1006 illustrates the THC conversion percentage associated with TWC converter system 9 at about 350° C. Still further to these embodiments, TWC converter systems 7, 8, and 9 exhibit THC conversion percentages of about 43.4%, 51.9%, and 45.6%, respectively. In these embodiments, TWC converter systems 8 and 9 each exhibit an improvement in THC conversion percentage as compared to TWC converter system 7.

In other embodiments, bar 1008 illustrates the THC conversion percentage associated with TWC converter system 7 at about 400° C. In these embodiments, bar 1010 illustrates the THC conversion percentage associated with TWC converter system 8 at about 400° C. Further to these embodiments, bar 1012 illustrates the THC conversion percentage associated with TWC converter system 9 at about 400° C. Still further to these embodiments, TWC converter systems 7, 8, and 9 exhibit THC conversion percentages of about 81.1%, 81.4%, and 80.8%, respectively. In these embodiments, TWC converter systems 7, 8, and 9 exhibit a substantially similar THC conversion percentage.

In further embodiments, bar 1014 illustrates the THC conversion percentage associated with TWC converter system 7 at about 500° C. In these embodiments, bar 1016 illustrates the THC conversion percentage associated with TWC converter system 8 at about 500° C. Further to these embodiments, bar 1018 illustrates the THC conversion percentage associated with TWC converter system 9 at about 500° C. Still further to these embodiments, TWC converter systems 7, 8, and 9 exhibit THC conversion percentages of about 96.2%, 96.4%, and 96.4%, respectively. In these embodiments, TWC converter systems 8 and 9 exhibit a slight improvement in THC conversion percentage as compared to TWC converter system 7.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system for treating the exhaust of a combustion engine, comprising:
at least one exhaust manifold suitable for accepting at least one stream of exhaust;
a closed-couple converter having a first catalyst body comprising at least one platinum group metal catalyst; and
an underfloor converter having a second catalyst body consisting of a zero platinum group metal;
wherein the at least one exhaust manifold is communicatively coupled to the closed-couple converter and underfloor converter.

2. The system of claim 1, wherein the at least one platinum group metal catalyst is selected from the group consisting of platinum (Pt), palladium (Pd), ruthenium (Ru), iridium (Ir), rhodium (Rd), and combinations thereof.

3. The system of claim 1, wherein the second catalyst body includes at least one platinum group metal.

4. The system of claim 1, wherein the first catalyst body comprises a substrate, a washcoat layer, and an overcoat layer.

5. The system of claim 1, wherein the at least one platinum group metal catalyst is supported on a support oxide.

6. The system of claim 5, wherein the support oxide is selected from the group consisting of MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂-10% ZrO₂, TiO₂-10% Nb₂O₅, SnO₂—TiO₂, ZrO₂—SnO₂—TiO₂, BaZrO₃, BaTiO₃, BaCeO₃, ZrO₂—P₆O₁₁, ZrO₂—Y₂O₃, ZrO₂—Nb₂O₅, Al—Zr—Nb, and Al—Zr—La, and combinations thereof,

7. The system of claim 1, wherein the zero platinum group metal catalyst is supported on a support oxide.

8. The system of claim 7, wherein the support oxide is selected from the group consisting of MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂-10% ZrO₂, TiO₂-10% Nb₂O₅, SnO₂—TiO₂, ZrO₂—SnO₂—TiO₂, BaZrO₃, BaTiO₃, BaCeO₃, ZrO₂—P₆O₁₁, ZrO₂—Y₂O₃, ZrO₂—Nb₂O₅, Al—Zr—Nb, and Al—Zr—La, and combinations thereof,

9. The system of claim 1, wherein the zero platinum group metal catalyst comprises a spinel structure.

10. The system of claim 1, wherein the platinum group metal catalyst comprises a spinel structure.

11. The system of claim 1, wherein the second catalyst body comprises a substrate, a washcoat layer, and an overcoat layer.

12. The system of claim 11, wherein the washcoat layer comprises a carrier material oxide selected from the group consisting of alumina, silica, titanium dioxide, zirconium oxide, cerium oxide, and mixtures thereof.

13. The system of claim 1, wherein the first catalyst body and second catalyst body provide a conversion of NO_{X} at greater than 80% at 350° C.

14. The system of claim 1, wherein the first catalyst body and second catalyst body provide a conversion of NO_{X} at greater than 95% at 500° C.

15. The system of claim 1, wherein the first catalyst body and second catalyst body provide a conversion of THC at greater than 80% at 400° C.

16. The system of claim 1, wherein the first catalyst body and second catalyst body provide a conversion of THC at greater than 90% at 400° C.

17. The system of claim 1, wherein the first catalyst body and second catalyst body provide a conversion of CO at greater than 60% at 350° C.

18. The system of claim 1, wherein the first catalyst body and second catalyst body provide a conversion of CO at greater than 70% at 500° C.

19. A method for optimizing a catalytic system, comprising:
providing a catalyst system into at least one stream of combustion exhaust, comprising:
a first catalyst body comprising at least one platinum group metal catalyst; and
a second catalyst body consisting of a zero platinum group metal;
wherein at least one of the first and second catalyst body is suitable for converting at least one of NO, CO and HC through oxidation or reduction.

20. The system of claim 19, wherein the at least one platinum group metal catalyst is selected from the group consisting of platinum (Pt), palladium (Pd), ruthenium (Ru), iridium (Ir), rhodium (Rd), and combinations thereof.

21. The system of claim 19, wherein the second catalyst body includes at least one platinum group metal.

22. The system of claim 19, wherein the first catalyst body comprises a substrate, a washcoat layer, and an overcoat layer.

23. The system of claim 19, wherein the at least one platinum group metal catalyst is supported on a support oxide.
